(19) United States
(12) Patent Application Publication
(10) Pub. No.: US 2012/0139989 A1
(43) Pub. Date: Jun. 7, 2012

(54) INK JET RECORDING APPARATUS

(75) Inventors: Kazuhiko Ohtsu, Shizuoka (JP); Hiroshi Kiyomoto, Shizuoka (JP); Takaya Kitawaki, Shizuoka (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/307,456

(22) Filed: Nov. 30, 2011

Related U.S. Application Data
(60) Provisional application No. 61/418,651, filed on Dec. 1, 2010.

(30) Foreign Application Priority Data
May 19, 2011 (JP) 2011-112125

(51) Int. Cl. B41J 29/377; B41J 2/01

(52) U.S. Cl. 347/17; 347/104

(57) ABSTRACT

An ink jet recording apparatus includes a storage part to store a recording medium, an image forming part that forms an image by ejecting an aqueous ink to the recording medium conveyed from the storage part, a separation part that includes a slit to allow the recording medium to pass from the storage part to the image forming part, and an opening and closing part to open and close the slit, and separates the storage part and the image forming part, a detection part to detect conveyance of the recording medium from the storage part to the image forming part, and a control part to control opening and closing of the opening and closing part in accordance with a detection result of the detection part.

### CROSS-REFERENCE TO RELATED APPLICATIONS

This application is based upon and claims the benefit of priority from U.S. Provisional Patent Application 61/418,651 filed on Dec. 1, 2010, the entire contents of which are incorporated herein by reference.

This application is based upon and claims the benefit of priority from Japanese Patent Application 2011-112125 filed on May 19, 2011, the entire contents of which are incorporated herein by reference.

### FIELD

Embodiments described herein relate generally to an ink jet recording apparatus.

### BACKGROUND

Recently, printing is often performed on a standard paper because an ink-jet dedicated coated paper or the like is high in cost and lacks in writing properties. However, when the standard paper is printed using an aqueous ink jet ink, curling occurs due to swelling of paper fibers caused by water in the ink. Especially, the curl remaining after several days causes such a problem that the image quality of a print is impaired.

### BRIEF DESCRIPTION OF THE DRAWINGS

FIG. 1 is a side sectional view of an ink jet recording apparatus in a first embodiment.

FIG. 2 is an enlarged view of an ink jet head, an ink cartridge and a tube in the first embodiment.

FIG. 3 is a block diagram of the ink jet recording apparatus in the first embodiment.

FIG. 4 is a view showing a separation part in a state where an opening and closing part is closed in the first embodiment.

FIG. 5 is a flowchart of opening and closing of the opening and closing part in the first embodiment.

FIG. 6 is a view showing the separation part in a state where the opening and closing part is opened in the first embodiment.

FIG. 7 is a graph showing the passage of time and the curl amount of a sheet in the first embodiment.

FIG. 8 is a view showing a curled sheet in the first embodiment.

FIG. 9 is an enlarged view of a separation part in a second embodiment.

FIG. 10 is a side sectional view of the separation part in the second embodiment.

FIG. 11 is a view showing a separation part in which an opening and closing part is closed in a third embodiment.

FIG. 12 is a view showing the separation part in which the opening and closing part is opened in the third embodiment.

### DETAILED DESCRIPTION

According to an embodiment, an ink jet recording apparatus includes a storage part to store a recording medium. An image forming part forms an image by ejecting an aqueous ink to the recording medium conveyed from the storage part. A separation part includes a slit to allow the recording medium to pass from the storage part to the image forming part, and an opening and closing part opens and closes the slit, and separates the storage part and the image forming part. A detection part detects conveyance of the recording medium from the storage part to the image forming part. A control part controls opening and closing of the opening and closing part in accordance with a detection result of the detection part.

Hereinafter, embodiments of an ink jet recording apparatus will be described with reference to the attached drawings.

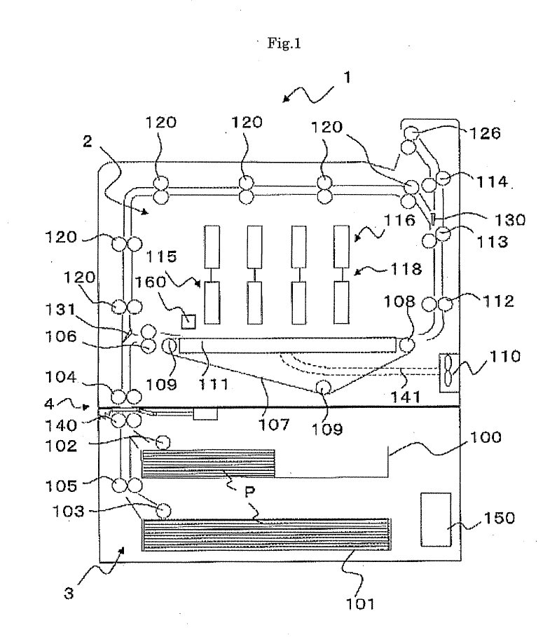

FIG. 1 is a side sectional view of an ink jet recording apparatus 1. The ink jet recording apparatus 1 includes an image forming part 2, a storage part 3 and a separation part 4.

The image forming part 2 ejects an aqueous ink to form an image on a surface of a sheet P. The image forming part 2 includes an ink jet head 115, an ink cartridge 116 and a tube 118.

The storage part 3 includes sheet cassettes 100 and 101 and a dehumidification part 150. The sheet cassettes 100 and 101 hold sheets P, and can be drawn out toward this side of FIG. 1. The dehumidification part 150 contains a dehumidification agent such as, for example, silica gel, and reduces the humidity of the storage part 3 and dries the sheets P held in the sheet cassettes 100 and 101. The dehumidification part 150 can contain other hygroscopic compounds or a mechanical dehumidification unit. The dehumidification part 150 makes the humidity of the storage part 3 lower than the humidity of the image forming part 2. The humidity of the storage part 3 is desirably lower than the humidity of the outer air of the ink jet recording apparatus 1.

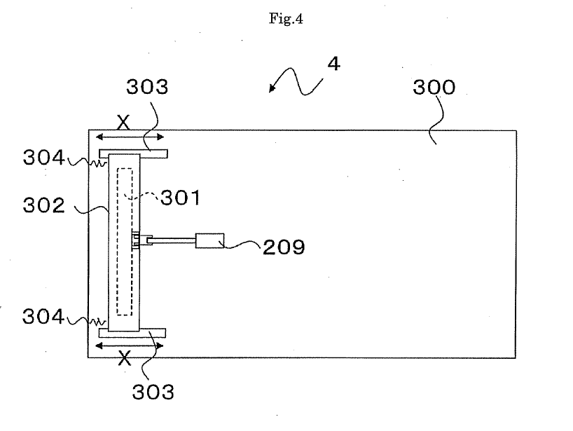

The separation part 4 separates the storage. part 3 and the image forming part 2, and prevents the humidity of the image forming part 2 from entering the storage part 3. In one embodiment, the separation part 4 is substantially impermeable to water vapor. The separation part 4 is defined to serve as a lower surface of the image forming part 2, or an upper surface of the storage part 3, or both the lower surface of the image forming part 2 and the upper surface of the storage part 3. In the first embodiment, although the image forming part 2 and the storage part 3 included in the ink jet recording apparatus 1 as one housing are separated by the separation part 4, no limitation is made to this arrangement. A structure may be such that the image forming part 2 and the storage part 3 are separate housings, and the image forming part 2 and the storage part 3 are stacked on each other. At this time, an overlapping portion of the image forming part 2 and the storage part 3 is the separation part 4. The separation part 4 will be described later in the description of FIG. 4.

The ink jet recording apparatus 1 includes paper feed rollers 102 and 103, conveyance roller pairs 104, 105, 112, 113, 114, 120 and 140, a registration roller pair 106, a conveyance belt 107, a drive roller 108, a driven roller 109, a fan 110, a negative pressure chamber 111, a paper discharge roller pair 126, conveyance guides 130 and 131, a duct 141 and a sensor 160.

The sheet cassettes 100 and 101 can hold sheets P with different sizes. The paper feed roller 102 takes out the sheet P corresponding to the selected sheet size from the sheet cassette 100, causes the sheet to pass through a slit 301 (described later) included in the separation part 4 from the conveyance roller pair 140, and conveys the sheet to the conveyance roller pair 104 and the registration roller pair 106. The paper feed roller 103 takes out the sheet P corresponding to the selected sheet size from the sheet cassette 101, causes the sheet to pass through the slit 301 included in the separation part 4 from the conveyance roller pair 105 and the conveyance roller pair 140, and conveys the sheet to the conveyance roller pair 104 and the registration roller pair 106.

A tensile force is given to the conveyance belt 107 by the drive roller 108 and the two driven rollers 109. A countless number of small holes are formed at specified intervals on a surface of the conveyance belt 107. At the inside of the conveyance belt 107, in order to cause the sheet P to be adsorbed to the conveyance belt 107, a top plate of the negative pressure chamber 11 coupled to the fan 110 through the duct 141 is in close contact with a back surface of the conveyance belt 107. The negative pressure chamber 111 includes an upper top plate having a number of grooves and holes and a hole for connecting the duct 141 for air discharge. The hollow inside thereof is set to negative pressure by suction of the fan 110, and a surface of the top plate contacts the surface of the conveyance belt 107.

The conveyance belt 107 is an endless belt formed by laminating rubber on fiber and by polishing the surface. The conveyance belt 107 can be such that an open-end belt of stainless steel or the like is subjected to a terminating process. The conveyance belt 107 adsorbs the sheet P to a conveyance surface of the conveyance belt 107 by a suction force generated by the fan 110 through the duct 141, the negative pressure chamber 111 and the large plurality number of small holes or pores on the conveyance belt 107.

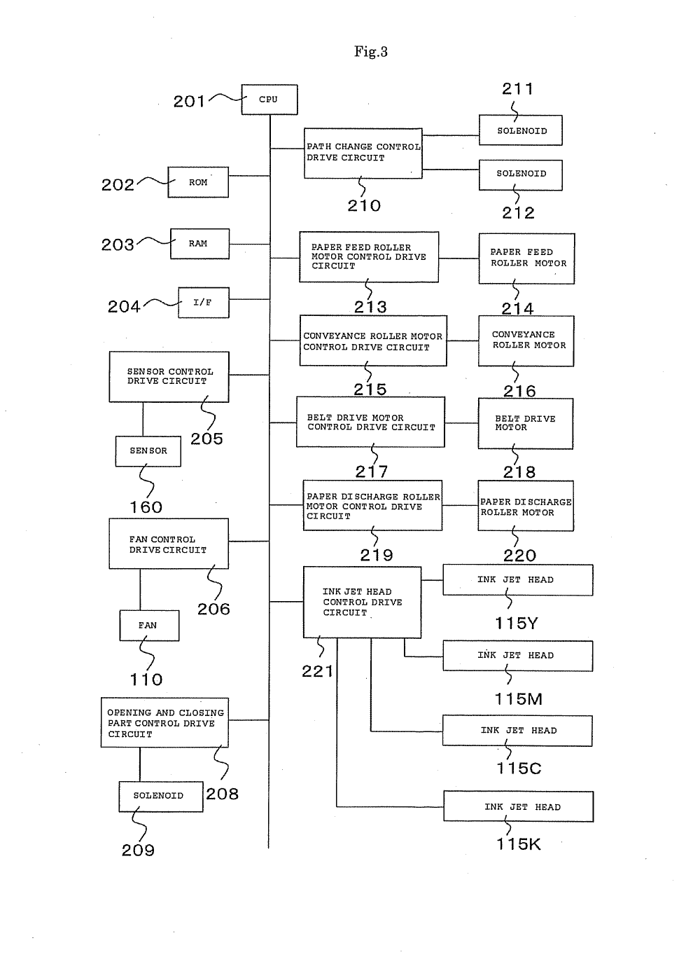

The conveyance roller pairs 112, 113 and 114 and the paper discharge roller pair 126 are provided at a paper discharge side. The conveyance roller pair 120 and the conveyance guides 130 and 131 again convey the sheet P to a paper feed side when two-sided printing is performed. The conveyance guides 130 and 131 change a conveyance route of the sheet P by solenoids 211 and 212 (shown in FIG. 3).

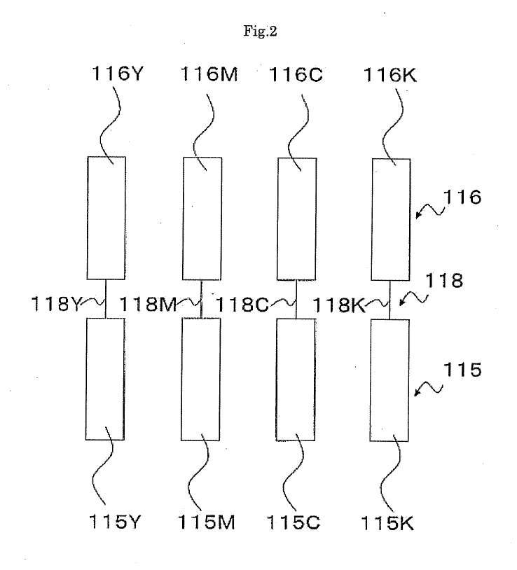

FIG. 2 is an enlarged view of the ink jet head 115, the ink cartridge 116 and the tube 118. Four lines of line-type ink jet heads 115 to eject ink to the sheet P according to image data are arranged above the conveyance belt 107, although the number of lines is not critical to the invention. The ink jet heads are disposed from the upstream side in order of an ink jet head 115Y to eject yellow (Y) ink, an ink jet head 115M to eject magenta (M) ink, an ink jet head 115C to eject cyan (C) ink, and an ink jet head 115K to eject black (K) ink.

Further, the respective ink jet heads 115 are provided with a yellow (Y) ink cartridge 116Y, a magenta (M) ink cartridge 116M, a cyan (C) ink cartridge 116C, and a black (K) ink cartridge 116K, in which respective color inks are stored, and they are coupled to each other through tubes 118Y, 118M, 118C and 118K.

The respective color inks are yellow, magenta, cyan and black, and an aqueous ink containing water in an amount of about 30 to 80 wt. % in the composition other than a solid content and an additive is used. In the above, although the structure is described in which an image is formed by inks of plural colors of yellow, magenta, cyan, and black, no limitation is made to this, and an image may be formed by a single color ink.

FIG. 3 is a block diagram of the ink jet recording apparatus 1. The ink jet recording apparatus 1 includes a CPU (Central Processing Unit) 201 as a control part, a ROM (Read Only Memory) 202 storing various programs and the like, a RAM (Random Access Memory) 203 temporarily storing various variable data and image data, and an interface (I/F) 204 to input data from the outside and to output data to the outside.

The ink jet recording apparatus 1 includes a paper feed roller motor control drive circuit 213 to control a paper feed roller motor 214 coupled to the paper feed rollers 102 and 103. Additionally, the ink jet recording apparatus 1 includes a conveyance roller motor control drive circuit 215 to control a conveyance roller motor 216 coupled to the plural conveyance roller pairs 104, 105, 112, 113, 114, 120 and 140 and the registration roller pair 106. Further, the ink jet recording apparatus 1 includes a belt drive motor control drive circuit 217 to control a belt drive motor 218 coupled to the drive roller 108, and a paper discharge roller motor control drive circuit 219 to control a paper discharge roller motor 220 coupled to the plural paper discharge roller pairs 126.

Optionally, the paper feed roller motor 214, the conveyance roller motor 216, the belt drive motor 218 and the paper discharge roller motor 220 can be one common motor.

The ink jet recording apparatus 1 includes a sensor control drive circuit 205 to control the sensor 160, and a fan control drive circuit 206 to control the fan 110. The ink jet recording apparatus 1 includes an opening and closing part control drive circuit 208 that is coupled to and controls a solenoid 209 to open and close an opening and closing part, and a path change control drive circuit 210 that is coupled to and controls the solenoids 211 and 212 to change the path. The ink jet recording apparatus 1 includes an ink jet head control drive circuit 221 to control the ink jet head 115Y, the ink jet head 115M, the ink jet head 115C and the ink jet head 115K.

The CPU 201 is connected to the ROM 202, the RAM 203, the I/F 204, the sensor control drive circuit 205, the fan control drive circuit 206, the opening and closing part control drive circuit 208, the path change control drive circuit 210, the paper feed roller motor control drive circuit 213, the conveyance roller motor control drive circuit 215, the belt drive motor control drive circuit 217, the paper discharge roller motor control drive circuit 219 and the ink jet head control drive circuit 221 through a bus.

The sensor 160 detects whether or not the sheet P passes through the slit. A detection result of the sensor 160 is transmitted to the CPU 201 through the sensor control drive circuit 205. The ink jet head 115Y, the ink jet head 115M, the ink jet head 115C and the ink jet head 115K eject inks to the sheet P from nozzles based on signals from the ink jet head control drive circuit 221.

Hereinafter, the separation part 4 will be described. The separation part 4 separates the image forming part 2 and the storage part 3.

In the image forming part 2, since the aqueous ink is sprayed to the sheet P from the ink jet head 115 for image formation, the humidity rises in the inside of the ink jet recording apparatus 1 which is isolated from the outer air and approaches saturation with water vapor. Thus, the separation part 4 separates the image forming part 2 and the storage part 3 so that the increased humidity of the image forming part 2 can not enter the storage part 3 where it can have detrimental effects.

FIG. 4 is a view showing the separation part 4 in a state where the opening and closing part is closed. A separation wall 300 is a wall to separate the image forming part 2 and the storage part 3. The separation wall 300 includes the slit 301 through which the sheet P passes from the storage part 3 to the image forming part 2 at the time of image formation, and further includes an opening and closing part 302 to close or open the slit 301. Additionally, the separation wall 300 includes a slide guide 303, a spring 304 and the solenoid 209. The vertical width of the opening and closing part 302 is large as compared with the vertical width of the slit 301, and the horizontal width of the opening and closing part 302 is large as compared with the horizontal width of the slit 301. When the opening and closing part 302 closes the slit 301, the opening and closing part 302 closes the slit 301 so as to cover the slit.

The openable and closeable opening and closing part 302 is attached to the slide guide 303 in a state slidable in an arrow X direction of FIG. 4. The opening and closing part 302 is fixed to the solenoid 209 through a link. The opening and closing part 302 and a fixed portion of the solenoid 209 can be flexibly coupled. One end of the spring 304 is fixed to the ink jet recording apparatus 1, and the other end is fixed to an end of the opening and closing part 302.

As shown in FIG. 4, the solenoid 209 is OFF at a time other than an image forming time, and closes the slit 301. At this time, the spring 304 is in the compressed state.

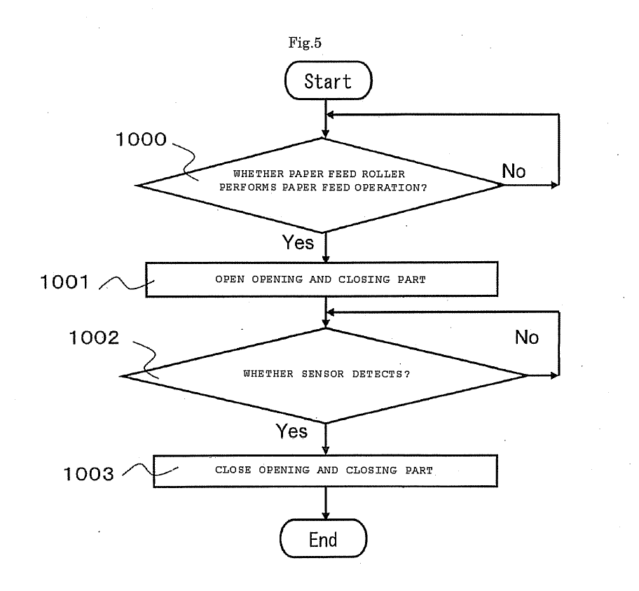

FIG. 5 is a flowchart of opening and closing of the opening and closing part 302. In the following description, the CPU 201 controls the ink jet recording apparatus 1. At Act 1000, a determination is made on whether or not the paper feed roller 102 or 103 performs a paper feed operation. When a user gives a print instruction, the paper feed roller 102 feeds the sheet P from the sheet cassette 100 of the storage part 3, or the paper feed roller 103 feeds the sheet P from the sheet cassette 101.

When the user does not give the print instruction and the paper feed roller 102 or 103 does not perform the paper feed operation (No at Act 1000), the opening and closing part 302 remains closed to close the slit 301, and the determination at Act 1000 is repeated.

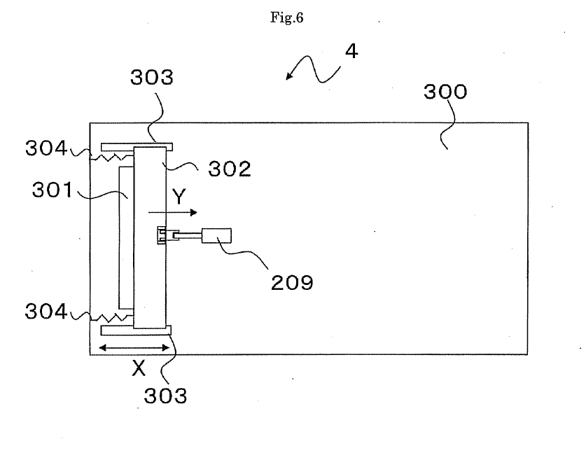

When the paper feed roller 102 or 103 is actuated (Yes at Act 1000), at Act 1001, in order to convey the sheet P to the image forming part 2 from the storage part 3, the opening and closing part 302 of the separation part 4 is opened, and the slit 301 is opened. FIG. 6 shows the separation part 4 in a state where the opening and closing part 302 is opened. As shown in FIG. 6, the opening and closing part 302 is moved in an arrow Y direction by turning ON the solenoid 209, and opens the slit 301. The opening and closing part 302 slides and moves along the slide guide 303, and the spring 304 is extended by the movement of the opening and closing part 302 in the arrow Y direction.

At Act 1001, the opening and closing part 302 is opened, and after the slit 301 is opened, at Act 1002, the sensor 160 detects passing of the sheet P to determine whether or not the conveyance of the sheet P to the image forming part 2 is completed. When the sensor 160 does not detect that the conveyance of the sheet P is completed (No at Act 1002), the determination at Act 1002 is repeated, and during that, the opening and closing part 302 maintains the open state, and the slit 301 is in the open state. When the sensor 160 detects that the conveyance of the sheet P is ended (Yes at Act 1002), the opening and closing part 302 is closed at Act 1003, the slit 301 is closed, and the process is terminated. When plural sheets P are continuously conveyed to the image forming part 2, after the conveyance of the continuously conveyed sheets is completed, the opening and closing part 302 is closed, the slit 301 is closed, and the process is terminated.

When the opening and closing part 302 is closed, the solenoid 209 is turned OFF, so that the opening and closing part 302 moves in the direction opposite to the arrow Y direction, and closes the slit 301. The opening and closing part 302 slides and moves along the slide guide 303 by the movement of the solenoid 209 in the direction opposite to the arrow Y direction, and the spring 304 returns to the state of FIG. 4. When the print instruction is not given, the opening and closing part 302 closes the slit 301 of the separation part 4, so that the sheet P stored in the storage part 3 is separated from the image forming part 2.

The opening and closing of the opening and closing part 302 may not be performed by the solenoid 209, and a motor can be used instead. Besides, although the embodiment is described in which the opening and closing part 302 is opened when the sheet P is fed by the paper feed roller, a sensor can be provided upstream of the passage of the slit 301 to detect paper feeding of the sheet P.

In the embodiment, the opening and closing part 302 and the solenoid 209 are provided on a lower surface of the separation wall 300, and when the opening and closing part 302 is moved in the arrow Y direction of FIG. 6, the slit 301 for conveying the sheet P is opened. However, no limitation is made to this structure, and the opening and closing part 302 and the solenoid 209 can be provided on an upper surface of the separation wall 300. Additionally, a structure can be such that the slit 301 is opened when the opening and closing part 302 is moved in the direction opposite to the arrow Y direction. Further, a structure can be such that the slit 301 is opened when the opening and closing part 302 is moved toward this side of FIG. 1 or in the direction opposite to this side.

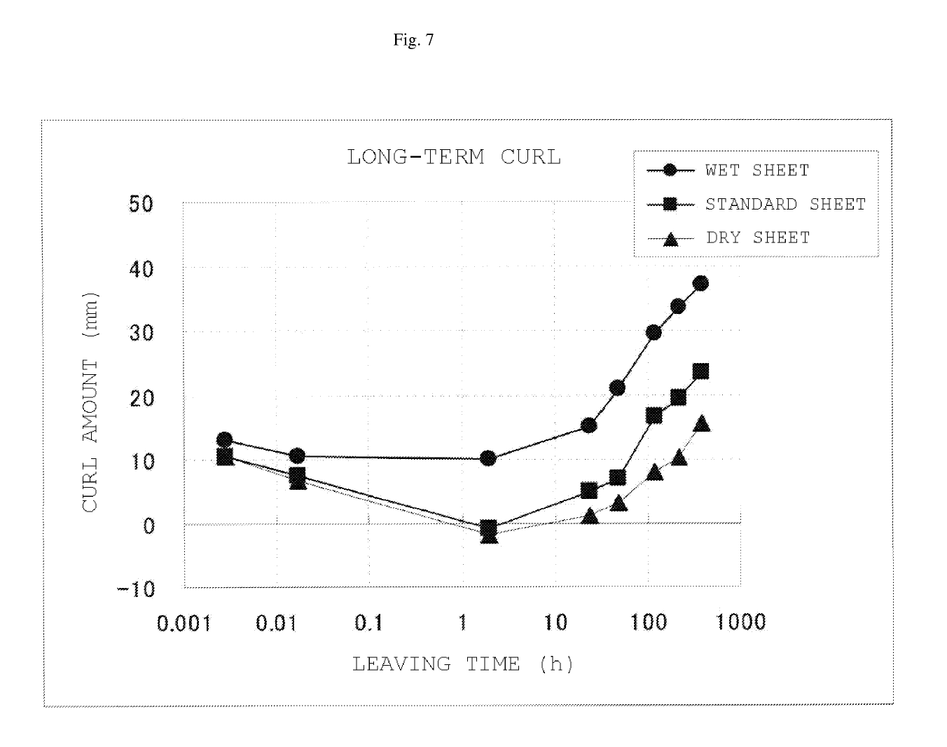

Hereinafter, the relation between the passage of time and the sheet curl amount according to sheet storage conditions will be described. FIG. 7 is a graph showing the passage of time and the sheet curl amount. FIG. 7 shows a result obtained by measuring the sheet curl amount with the passage of time when image formation using full-surface solid printing is performed by using an aqueous ink having a water content of about 50 wt. % with respect to three kinds of sheets, that is, a wet sheet, a standard sheet and a dry sheet. The wet sheet is a sheet which is left in an environment of 35 □C and 80% RH (relative, humidity) for 24 hours or more. The standard sheet is a sheet which is left in an environment of 25 □C and 50% RH for 24 hours or more. The dry sheet is a sheet which is left in an environment of 10 □C and 20% RH for 24 hours or more.

As shown in FIG. 7, a curl slightly occurs after printing, and after several hours, the curl amount decreases. However, thereafter, there is a tendency that the curl amount gradually increases. In the graph of FIG. 7, the curl amount in the direction in which the curl of the sheet occurs immediately after printing is assumed to have a positive value. When the leaving time exceeds about three hours, the standard sheet and the dry sheet have negative values although they are small. This indicates that a curl slightly occurs in the direction opposite to the direction of the curl which occurred immediately after printing.

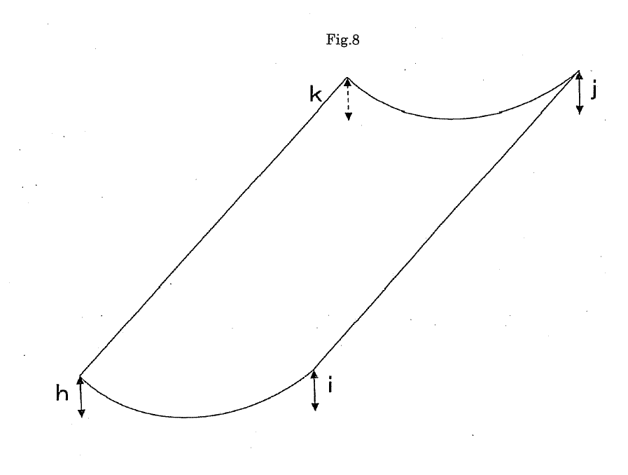

The curl amount is defined such that a sheet subjected to image recording by full-surface solid printing using an aqueous ink is placed on a plane, the length of the upward curl from the, plane is measured at four corners of the sheet, and an average length of the curls at the four corners is defined as the curl amount. FIG. 8 is a view showing a curled sheet which is subjected to the image recording by full-surface solid printing using an aqueous ink. The curl amount of the sheet is obtained by dividing the sum of the curl amounts (h+i+j+k) at the four corners by 4.

As shown in FIG. 7, as the sheet becomes wet, the curl amount increases with the passage of time, and as the sheet becomes dry, the curl amount is suppressed or decreases with the passage of time. As stated above, when the wet sheet is subjected to the full-surface solid printing by the aqueous ink jet head, and then is left in the environment with humidity lower than the environment in which the sheet P was stored, the curl amount of the sheet P subjected to the full-surface solid printing increases. On the other hand, when the sheet P stored in the dry humidity environment is subjected to the full-surface solid printing by the aqueous ink jet head, and then is left in the environment with humidity higher than the environment in which the sheet was stored, the curl amount of the sheet P subjected to the full-surface solid printing is suppressed. That is, when the environment in which the sheet P is stored is made drier than the environment which is outside the apparatus and into which the sheet P is discharged, the curl of the sheet P can be advantageously suppressed.

According to the first embodiment, the separation part 4 separates the sheet P stored in the storage part 3 and the image forming part 2, and prevents the humidity of the image forming part 2 from entering the storage part 3, so that the curl of the sheet P after image formation can be suppressed.

### Second Embodiment

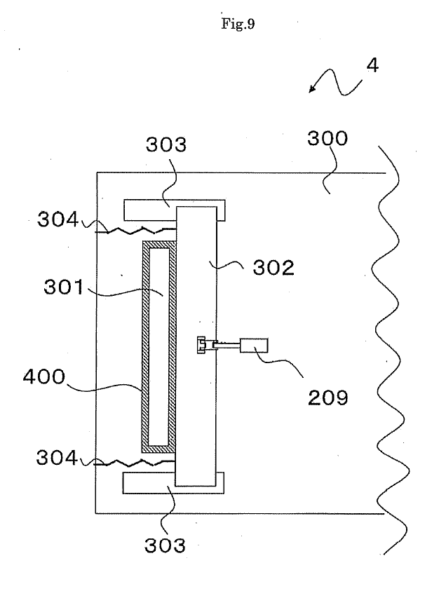

In a second embodiment shown in FIG. 9, an elastic member 400 is provided at an edge of a slit 301 of a separation part 4. In the drawing, the same component as that of the first embodiment is denoted by the same reference numeral. The second embodiment is different from the first embodiment in the structure of the separation part 4 in the side sectional view of the ink jet recording apparatus 1 described in FIG. 1.

FIG. 9 is an enlarged view of the slit 301 of the separation part 4 in the second embodiment. A separation wall 300 allows a sheet P to pass from a storage part 3 to an image forming part 2 at the time of image formation. The separation wall 300 includes the slit 301. Further, the separation wall 300 includes an opening and closing part 302. The opening and closing part 302 closes or opens the slit 301. The separation wall 300 includes the elastic member 400 at the edge of the slit 301 and on the side contacting the opening and closing part 302. Besides, the separation wall 300 includes a slide guide 303, a spring 304 and a solenoid 209. The elastic member 400 provided at the edge of the slit 301 is, for example, rubber or urethane.

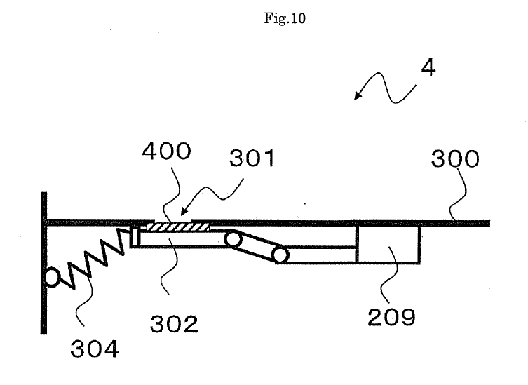

FIG. 10 is a side sectional view of the separation part 4 in the second embodiment. An oblique line part of FIG. 9 and FIG. 10 indicates the elastic member 400. When the opening and closing part 302 is closed, the elastic member 400 provided at the edge of the slit 301 is pressed by the opening and closing part 302. As stated above, the opening and closing part 302 presses the elastic member 400, so that the opening and closing part 302 is closed without a gap, and can close the slit 301.

The curl of the sheet P can be suppressed by the ink jet recording apparatus 1 having the structure as stated above. Besides, the slit 301 is provided with the elastic member 400, and when the opening and closing part 302 is closed, the opening and closing part 302 presses the elastic member 400, so that the slit 301 can be closed without a gap, and the curl of the sheet P can be more suppressed.

In the storage part 3 of the ink jet recording apparatus 1, an elastic member may be provided in a gap through which the outer air is introduced. Although the sheet cassettes 100 and 101 of FIG. 1 can be drawn out toward this side of the drawing, for example, the elastic member 400 may be provided in the gap through which the outer air is introduced when the sheet cassettes 100 and 101 are drawn out. Alternatively, a structure can be such that instead of providing the elastic member 400 at the edge of the slit 301, the opening and closing part 302 is made of an elastic member, and when the opening and closing part 302 is closed, and the slit 301 is closed, the separation wall 300 is pressed. Still alternatively, the elastic member 400 is provided at the edge of the slit 301, and further, the opening and closing part 302 may be formed of the elastic member.

### Third Embodiment

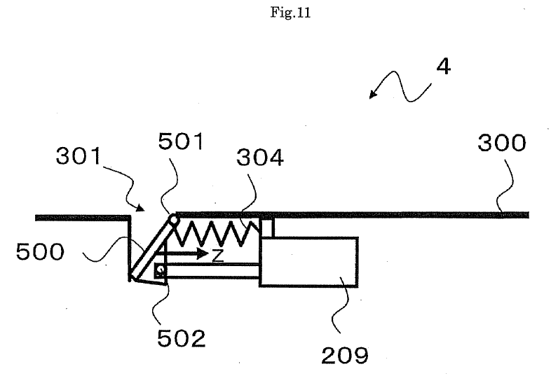

In a third embodiment shown in FIG. 11, a slit 301 is opened or closed by rotation of an opening and closing part 500. In the drawing, the same component as that of the first embodiment is denoted by the same reference numeral. The third embodiment is different from the first embodiment in the structure of the separation part 4 in the side sectional view of the ink jet recording apparatus 1 described in FIG. 1.

A separation part 4 includes the slit 301 to allow a sheet P to pass, and is provided with the opening and closing part 500 to open and close the slit 301. The separation part 4 includes a solenoid 209, a separation wall 300, the slit 301, a spring 304, and the opening and closing part 500. One end of the opening and closing part 500 is fixed to the separation wall 300 by a shaft 501, and the opening and closing part is further fixed to the solenoid 209 by a shaft 502. The opening and closing part 500 can be rotated around the shafts 501 and 502. One end of the spring 304 is fixed to the separation wall 300, and the other end is fixed to the opening and closing part 500. The spring 304 is expanded and compressed by opening and closing of the opening and closing part 500. When the solenoid 209 is OFF, the opening and closing part 500 is closed to close the slit 301, and when the solenoid 209 is ON, the opening and closing part 500 is opened to open the slit 301.

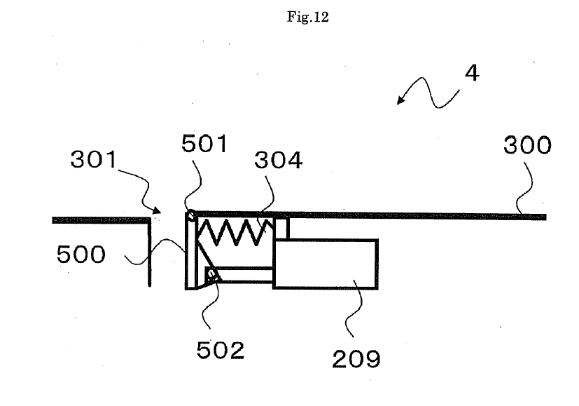

When a print instruction is given and the sheet P is not fed from a storage part 3, as shown in FIG. 11, the opening and closing part 500 is closed and the slit 301 is closed. When the sheet P stored in the storage part 3 is conveyed to an image forming part 2 based on the print instruction, the solenoid 209 is turned ON, and the opening and closing part 500 moves in an arrow Z direction and rotates around the shafts 501 and 502. FIG. 12 is a view showing a state in which the opening and closing part 500 is rotated and the slit 301 is opened. At this time, the spring 304 is in a compressed state.

After it is confirmed that the sheet P is conveyed from the storage part 3 to the image forming part 2, the solenoid 209 is turned OFF, and the opening and closing part 500 moves in the direction opposite to the arrow Z direction, so that a return is made to the state of FIG. 11.

Other than where otherwise indicated, all numbers, values and/or expressions referring to quantities of ingredients, water vapor, etc., used in the specification and claims are to be understood as modified in all instances by the term “about.”

While certain embodiments have been described, these embodiments have been presented by way of example only, and are not intended to limit the scope of the invention. These novel embodiments may be embodied in a variety of other forms, and various omissions, substitutions and changes may be made without departing from the gist of the invention. These embodiments and their modifications are included in the scope of the invention, and are included in the scope of the invention recited in claims and their equivalents. The first embodiment, the second embodiment and the third embodiment may be combined.

What is claimed is:

1. An ink jet recording apparatus comprising:
a storage part to store a recording medium;
an image forming part that forms an image by ejecting an aqueous ink to the recording medium conveyed from the storage part;
a separation part that includes a slit to allow the recording medium to pass from the storage part to the image forming part, and an opening and closing part to open and close the slit, and separates the storage part from the image forming part;
a detection part to detect conveyance of the recording medium from the storage part to the image forming part; and
a control part to control opening and closing of the opening and closing part in accordance with a detection result of the detection part.

2. The apparatus of claim 1, further comprising a dehumidification part to dehumidify the storage part.

3. The apparatus of claim 1, wherein a vertical width of the opening and closing part is larger than a vertical width of the slit, a horizontal width of the opening and closing part is larger than a horizontal width of the slit, and the opening and closing part covers the slit.

4. The apparatus of claim 1, wherein the detection part includes a first detection part to detect that the recording medium is fed from the storage part, and a second detection part to detect that the recording medium is conveyed to the image forming part.

5. The apparatus of claim 4, wherein when the first detection part detects paper feeding of the recording medium, the opening and closing part is moved to open the slit, and when the second detection part detects that the recording medium is conveyed to the image forming part, the opening and closing part is moved to close the slit.

6. The apparatus of claim 1, further comprising an elastic member at an edge of the slit and on a side contacting the opening and closing part of the separation part.

7. The apparatus of claim 6, wherein when the opening and closing part closes the slit, the opening and closing part presses the elastic member.

8. An ink jet recording apparatus comprising:
a storage part to store a recording medium; and
an image forming part that forms an image by ejecting an aqueous ink to the recording medium conveyed from the storage part, wherein
the storage part is separated from the image forming part by a separation part that includes a slit to allow the recording medium to pass and an opening and closing part to open and close the slit.

9. The apparatus of claim 8, further comprising a dehumidification part to dehumidify the storage part.

10. An image forming method of an ink jet recording apparatus including a slit, a separation part and a opening and closing part, comprising:
opening the slit to allow a recording medium to pass from a storage part to an image forming part of an ink jet recording apparatus;
conveying the recording medium from the storage part to the image forming part through the slit;
detecting conveyance of the recording medium from the storage part to the image forming part;
closing the slit; and
forming an image by ejecting an aqueous ink onto the recording medium.

11. The method of claim 10, further comprising:
dehumidifying the storage part using a dehumidification part.

12. The method of claim 10, further comprising:
while closing the slit, the opening and closing part pressing an elastic member.
